(19) United States
(12) Patent Application Publication
(10) Pub. No.: US 2008/0094197 A1
(43) Pub. Date: Apr. 24, 2008

(54) TIRE PRESSURE MONITORING SYSTEM WITH BIDIRECTIONAL COMMUNICATION FUNCTION

(76) Inventor: Tien-Tsai Huang, Pan-Chiao (TW)

Correspondence Address: PAI PATENT & TRADEMARK LAW FIRM, 1001 FOURTH AVENUE, SUITE 3200, SEATTLE, WA, 98154, US

(21) Appl. No.: 11/615,961

(22) Filed: Dec. 23, 2006

(30) Foreign Application Priority Data
Oct. 24, 2006 (TW) 95139251

(51) Int. Cl. B60C 23/00

(52) U.S. Cl. 340/447

(57) ABSTRACT

A tire pressure monitoring system with bidirectional communication function includes sensing units mounted on tires of a vehicle for sensing tire pressures and wirelessly transmitting tire pressure signals; a wireless receiver and a wireless transmitter mounted near a rear and a front end of the vehicle, respectively, the wireless receiver receiving tire pressure signals transmitted from the sensing units on tires closer to the rear end of the vehicle, the wireless transmitter being connected to the wireless receiver via a signal line, so as to receive tire pressure signals from the wireless receiver and wirelessly transmit integrated tire pressure signals; a second wireless module and/or a portable monitoring module for receiving and displaying the tire pressure signals transmitted from the wireless transmitter.

### RELATED APPLICATIONS

The present application is based on, and claims priority from, Taiwan Application Serial Number 95139251, filed Oct. 24, 2006, the disclosure of which is hereby incorporated by reference herein in its entirety.

### FIELD OF THE INVENTION

The present invention relates to a tire pressure monitoring system with bidirectional communication function, and more particularly to a tire monitoring system suitable for detecting pressures of tires spaced at a long distance and capable of showing detected tire pressures information on different platforms.

### BACKGROUND OF THE INVENTION

Tires have very important influence on safe driving, and tire pressure plays an important factor in normal operation of a tire. There are many differently configured tire pressure detecting products available in the market. Most of the currently widely accepted tire-pressure detecting products include a tire pressure sensor mounted on each tire. Each of the tire pressure sensors is associated with a wireless transmitting unit, so as to wirelessly transmit signals indicating the tire pressures of all tires to a display unit pre-mounted in a car, allowing a driver to timely control the tire pressure condition of all tires to ensure safe driving.

Since the display unit is mounted in the car, the driver must get on the car or even power on the car to view the tire pressure detection results shown on the display unit. Therefore, the conventional tire pressure detecting products are not so convenient for use because a driver or a car maintenance worker is not able to know the tire pressure condition when the car is in a still or power-off state. To overcome this problem, Taiwan New Utility Model Patent Application No. 90215526, which has already been published under Publication No. 534007, discloses a Remote Tire Pressure Detecting, Displaying, and Warning System that allows display of tire pressure condition when a car system power source is turned off, and includes a portable display unit to provide the remote display function. Therefore, the remote tire pressure detecting, displaying, and warning system eliminates the disadvantages in the conventional tire pressure detecting products, and is more convenient for use.

Moreover, due to cost and other objective factors, the wireless transmitting units associated with the tire pressure sensors in the conventional tire pressure detecting products can only transmit electric waves having a relatively small power as required by relevant codes. As a result, the wireless signals indicating tire pressures can only be transmitted within a limited range, which is not suitable for a somewhat big-size vehicle, such as a trailer, a truck, etc.

Therefore, it is desirable to improve the currently available tire pressure detecting products, so as to increase the tire pressure signal transmission range and allow the tire pressure detecting products to be used on big-size vehicles.

### SUMMARY OF THE INVENTION

A primary object of the present invention is to provide a tire pressure monitoring system with bidirectional communication function to enable transmission of tire pressure signals in an extended range, so that the tire pressure monitoring system may have widened range of applications.

To achieve the above object, the tire pressure monitoring system with bidirectional communication function according to the present invention mainly includes a plurality of sensing units, and a first and a second wireless module. The sensing units are separately mounted on tires located at a head portion and a body portion of a vehicle, and each of the sensing units includes at least one pressure sensor, a third power supply, and a third wireless transmitter. Each of the pressure sensors is adapted to sense tire pressure of a corresponding tire to be monitored. The third wireless transmitter is adapted to wirelessly transmit tire pressure signals; and the third power supply supplies power needed by the at least one pressure sensor and the third wireless transmitter. The first wireless module is mounted on the body portion of the vehicle, and includes a first wireless receiver and a first wireless transmitter; the first wireless receiver being located near a rear end of the vehicle body portion farther from the head portion for receiving tire pressure signals transmitted by the sensing units on the tires nearer the rear end of the vehicle body portion; and the first wireless transmitter being located near a front end of the vehicle body portion closer to the vehicle head portion for receiving tire pressure signals from the first wireless receiver, and then wirelessly sending out the tire pressure signals. The second wireless module is mounted in the vehicle head portion, and includes a second wireless receiver and a display unit; the second wireless receiver being adapted to receive tire pressure signals sent by the first wireless transmitter, and the display unit being adapted to display tire pressures of the tires being monitored. According to the present invention, since tire pressure signals may be transmitted from the first wireless receiver to the first wireless transmitter of the first wireless module, the problem of failing to transmit tire pressure signals over an extended distance as encountered in the conventional tire pressure monitoring systems or tire pressure detecting products may be overcome.

The second wireless module may further include a second wireless transmitter for transmitting detection signals indicating information about the pressure, number, position, ID, and temperature of all tires of the vehicle.

Another object of the present invention is to provide a tire pressure monitoring system with bidirectional communication function, in which a portable monitoring module is further provided, so that the tire pressure monitoring system is more convenient for use.

To achieve the above object, the tire pressure monitoring system with bidirectional communication function according to the present invention further includes a portable monitoring module, which includes at least a fourth wireless receiver and a display panel. The fourth wireless receiver is adapted to receive tire pressure signals transmitted from the first or the second wireless transmitter, and the display panel is adapted to directly display information about the pressure, number, position, ID, and temperature of each tire being monitored. With the remotely receiving and displaying functions of the portable monitoring module, the tire pressure monitoring system of the present invention is more convenient for use.

A further object of the present invention is to provide a tire pressure monitoring system with bidirectional communication function, so that integrated tire pressure signals may be timely transmitted out for use.

To achieve the above object, the portable monitoring module according to the present invention further includes a control interface and a fourth wireless transmitter. A user may operate on the control interface to transmit a control signal for controlling the first or the second wireless transmitter, so that the first or the second wireless transmitter under control of the portable monitoring module may timely transmit integrated tire pressure signals.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic plan view showing a tire pressure monitoring system with bidirectional communication function according to a first embodiment of the present invention;

FIG. 2 is a schematic plan view showing a tire pressure monitoring system with bidirectional communication function according to a second embodiment of the present invention;

FIG. 3 is an enlarged perspective view showing how a sensing unit included in the present invention is mounted on tires;

FIG. 4 is a block diagram showing an internal structure of the sensing unit in the present invention;

FIG. 5 is a schematic plan view showing a tire pressure monitoring system with bidirectional communication function according to a third embodiment of the present invention;

FIG. 6 is a schematic plan view showing a tire pressure monitoring system with bidirectional communication function according to a fourth embodiment of the present invention;

FIG. 7 is a schematic plan view showing a tire pressure monitoring system with bidirectional communication function according to a fifth embodiment of the present invention; and

FIG. 8 is a schematic plan view showing a tire pressure monitoring system with bidirectional communication function according to a sixth embodiment of the present invention;

### DETAILED DESCRIPTION OF THE PREFERRED EMBODIMENTS

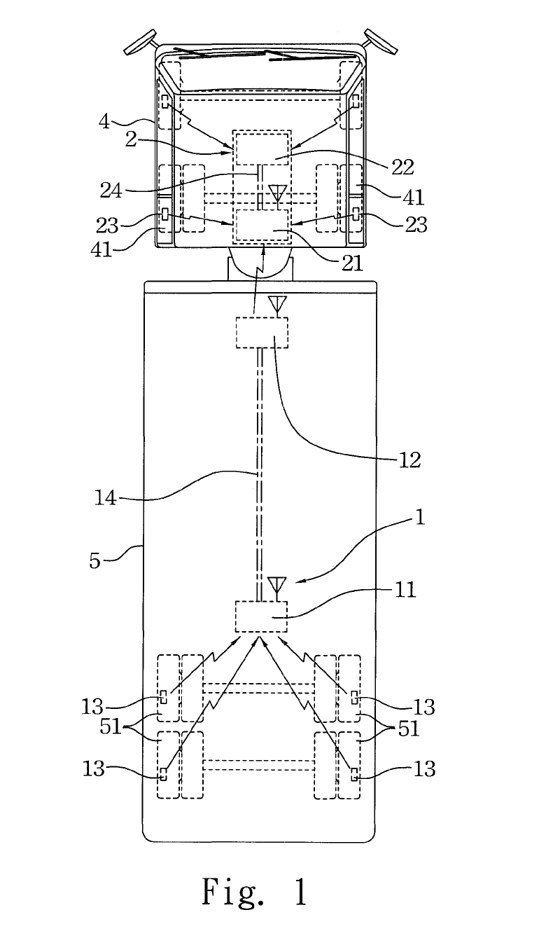

Referring to FIG. 1, a schematic plan view showing the configuration of a tire pressure monitoring system with bidirectional communication function according to a first embodiment of the present invention, the first embodiment of the present invention mainly includes a first wireless module 1 and a second wireless module 2, and is suitable for use with a vehicle having separably connected head portion 4 and body portion 5, such as a combination vehicle having a tractor and a trailer.

The first wireless module 1 is mounted on the vehicle body portion 5, and includes a first wireless receiver 11 and a first wireless transmitter 12. The first wireless receiver 11 is located near a rear end of the body portion 5 farther from the head portion 4 for receiving tire pressure signals sent by sensing units 13 mounted on rear tires 51, which are located closer to the rear end of the body portion 5.

The first wireless transmitter 12 is located near a front end of the body portion 5 closer to the head portion 4, and is electrically connected to the first wireless receiver 11 via a first signal line 14, so as to receive tire pressure signals from the first wireless receiver 11 in a wired manner, integrate the received signals, and then transmit an integrated tire pressure signal. The second wireless module 2 is mounted in the vehicle head portion 4, and includes a second wireless receiver 21 and a display unit 22. The second wireless receiver 21 is adapted to receive the tire pressure signals sent by the first wireless transmitter 12 of the first wireless module 1, as well as the tire pressure signals sent by sensing units 23 mounted on front tires 41, which are located below the head portion 4. The display unit 22 is electrically connected to the second wireless receiver 21 via a second signal line 24, so as to display information received by the second wireless receiver 21.

What is to be noted is, in the first embodiment, a wired signal transmission is adopted between the first wireless receiver 11 and the first wireless transmitter 12 of the first wireless module 1, as well as between the second wireless receiver 21 and the display unit 22 of the second wireless module 2. However, it is understood a wireless signal transmission may also be adopted for the first and the second wireless module 1, 2.

In practical application of the present invention, when the head portion 4 is coupled to the body portion 5, the second wireless receiver 21 of the second wireless module 2 mounted in the head portion 4 is able to automatically receive not only the tire pressure signals sent by the sensing units 23 on the front tires 41, but also the integrated tire pressure signals sent by the first wireless transmitter 12 of the first wireless module 1 mounted on the body portion 5. The current tire pressure conditions of the tires 41, 51 indicated by the received tire pressure signals are then shown on the display unit 22. Therefore, the present invention enables a driver to control the exact pressure condition of the tires 41, 51 at any time to ensure safe driving.

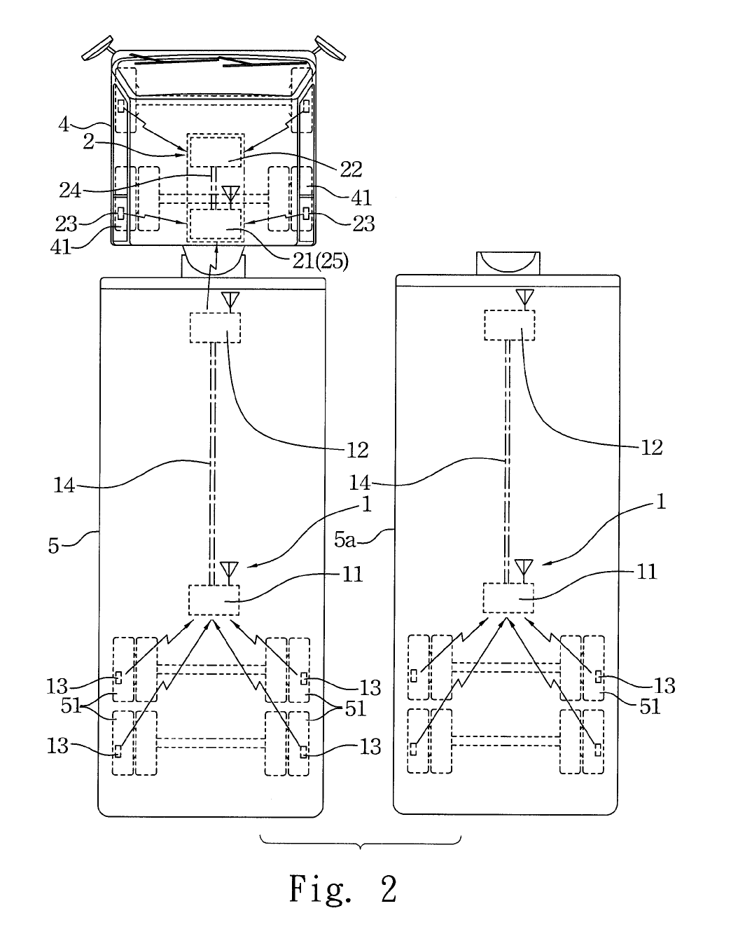

As shown in FIG. 2, the second embodiment of the present invention is generally structurally similar to the first embodiment, except for a second wireless module 2 that further includes a second wireless transmitter 25 adapted to wirelessly transmit detection signals indicating information about all the tires of the vehicle, including the pressure, number, position, ID, and temperature of all tires being monitored. And,when the same one vehicle head portion 4 is to be coupled to a different body portion 5 or 5a, the second wireless transmitter 25 may transmit to each different body portion 5 or 5a a detection signal for identifying purpose, such as information about the number, position, ID, and temperature of tires, so as to ensure the head portion 4 is suitable for use with different body portions 5. Therefore, the display unit 22 in the head portion 4 may show information not only about the positions of the front tires 41, but also the positions of the rear tires 51.

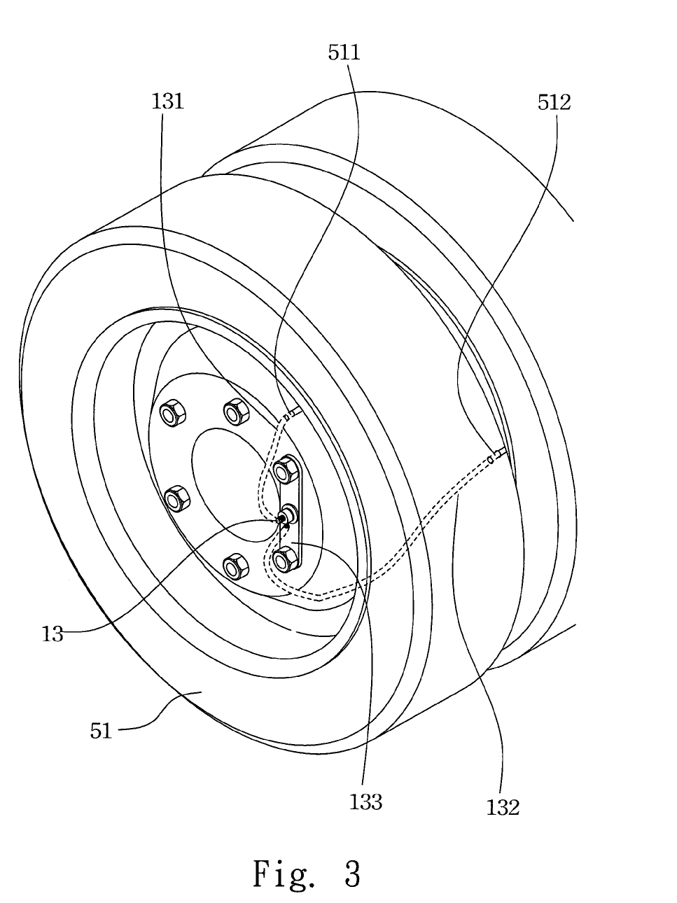

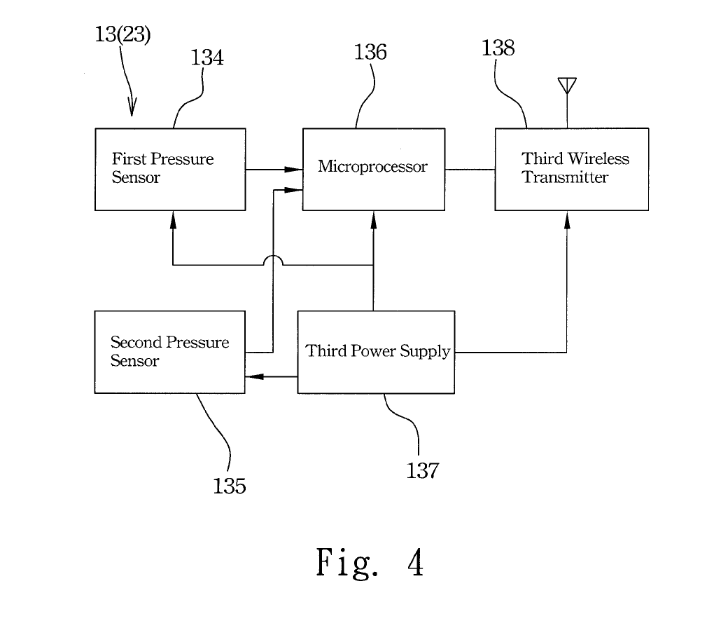

FIG. 3 shows how the sensing unit is mounted to a tire, and FIG. 4 is a block diagram showing an internal structure of the sensing unit. It is known a big-size vehicle usually includes several pairs of twin wheels to serve as load-bearing wheels. As can be seen from FIG. 3, the sensing unit 13 (23) in the present invention is fixedly mounted via a bracket 133 to the wheel rim of an outer wheel in one pair of twin wheels; and two tubes 131, 132 are separately extended from the sensing unit 13 (23) to the inflation valves 511, 512 on two tires 51 (41) of the same one pair of twin wheels, so that internal pressure of the two tires 51 (41) are guided to the sensing unit 13 (23). Referring to FIG. 4, each of the sensing units 13 (23) internally includes a first and a second pressure sensor 134, 135, a microprocessor 136, a third power supply 137, and a third wireless transmitter 138. The first and second pressure sensors 134, 135 separately receive the tire pressures of the two tires 51 (41) to respectively generate a tire pressure signal. The generated tire pressure signals are input to the microprocessor 136 to be processed and integrated, and then wirelessly transmitted via the third wireless transmitter 138. The third power supply 137 supplies power needed by the microprocessor 136, the third wireless transmitter 138, and the first and second pressure sensors 134, 135.

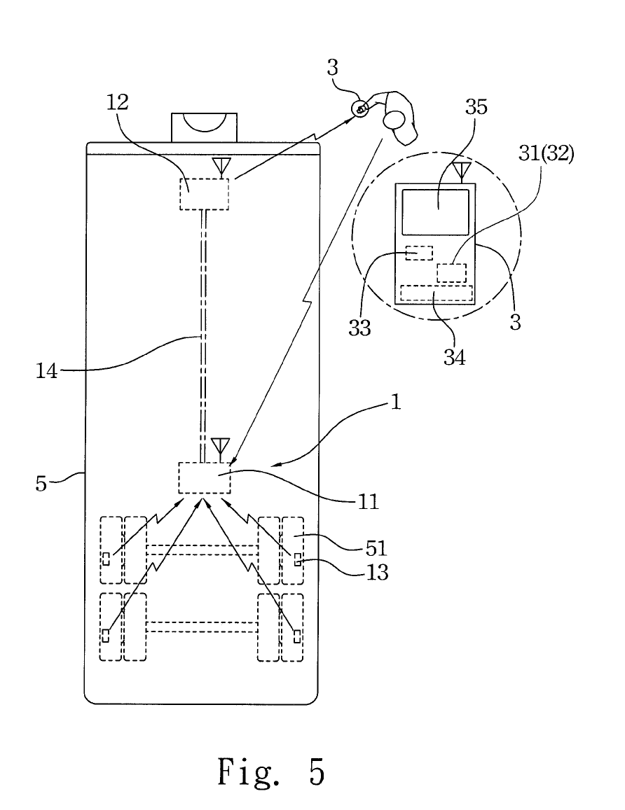

As shown in FIG. 5, the third embodiment of the present invention mainly includes a first wireless module 1 and a portable monitoring module 3.

The first wireless module 1 includes a first wireless receiver 11 and a first wireless transmitter 12, both of which are mounted on the vehicle body portion 5 at positions and in connection manner similar to those in the first embodiment.

The portable monitoring module 3 is portable and includes a fourth wireless receiver 31, a fourth wireless transmitter 32, a control interface 33, a fourth power supply 34, and a display panel 35. A user may operate at the control interface 33, so that a control signal is transmitted via the fourth wireless transmitter 32 to the first wireless receiver 11 of the first wireless module 1. When the first wireless receiver 11 receives the control signal, the first wireless transmitter 12 would timely transmit integrated tire pressure signals, which are received by the fourth wireless receiver 31 in the portable monitoring module 3, so that tire pressures of tires being monitored are shown on the display panel 35. The third embodiment of the present invention provides remote tire pressure signal receiving and displaying function to increase the convenience in using the tire pressure monitoring system and reduce power being consumed in starting the vehicle. The fourth power supply 34 supplies power needed by the fourth wireless receiver 31, the fourth wireless transmitter 32, the control interface 33, and the display panel 35.

The above-mentioned wireless transmitters and wireless receivers are radio-frequency (RF) transmitters and receivers, respectively. Since the first and second pressure sensors 134, 135 have basic structure and application principle the same as those disclosed in Taiwan New Utility Model Patent Application No. 90215526, which has already been published under Pub. No. 534007, entitled “Remote Tire Pressure Detecting, Displaying, and Warning System”, they are not discussed in details herein.

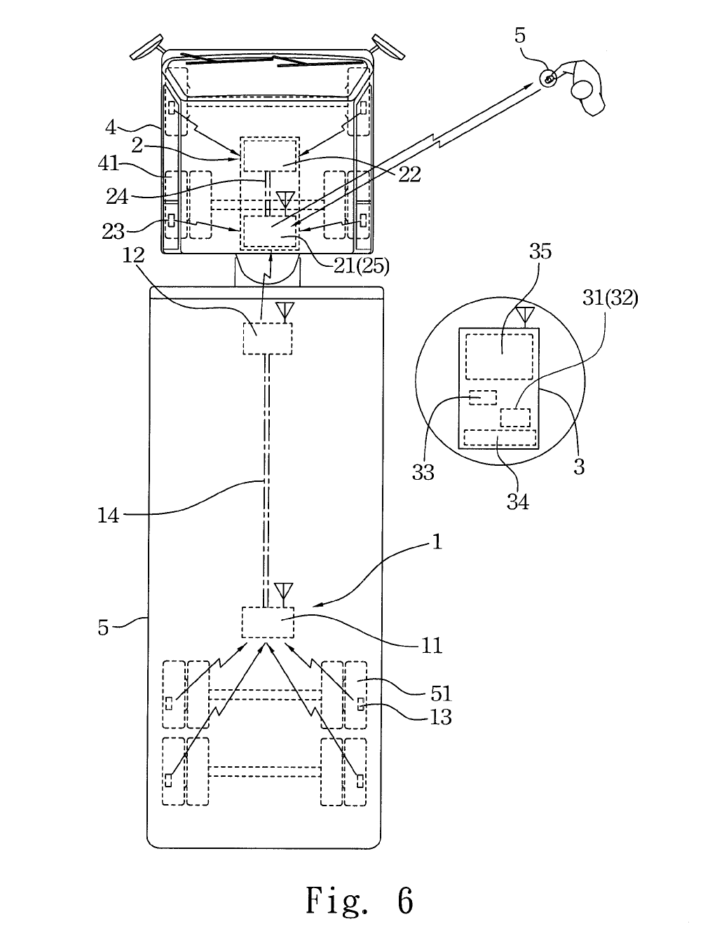

The fourth embodiment of the present invention, as shown in FIG. 6, is a combination of the above-described second and third embodiments, and mainly includes a first wireless module 1, a second wireless module 2, and a portable monitoring module 3. All the three modules 1, 2, and 3 have structures the same as those in the previous embodiments. A user may operate at the control interface 33 of the portable monitoring module 3, so that a control signal is transmitted via the fourth wireless transmitter 32 to the second wireless receiver 21 of the second wireless module 2. Meanwhile, both the signals indicating the tire pressures of the rear tires 51 transmitted from the first wireless transmitter 12 of the first wireless module 1, as well as the signals indicating the tire pressures of the front tires 41 transmitted from the sensing units 23 may be received by the second wireless receiver 21 of the second wireless module 2, and be transmitted by the second wireless transmitter 25 to the portable monitoring module 3. Therefore, the tire pressures of all rear tires 51 of the body portion 5 and all front tires 41 of the head portion 4 may be shown not only on the display unit 22 in the head portion 4, but also on the display panel 35 on the portable monitoring module 3.

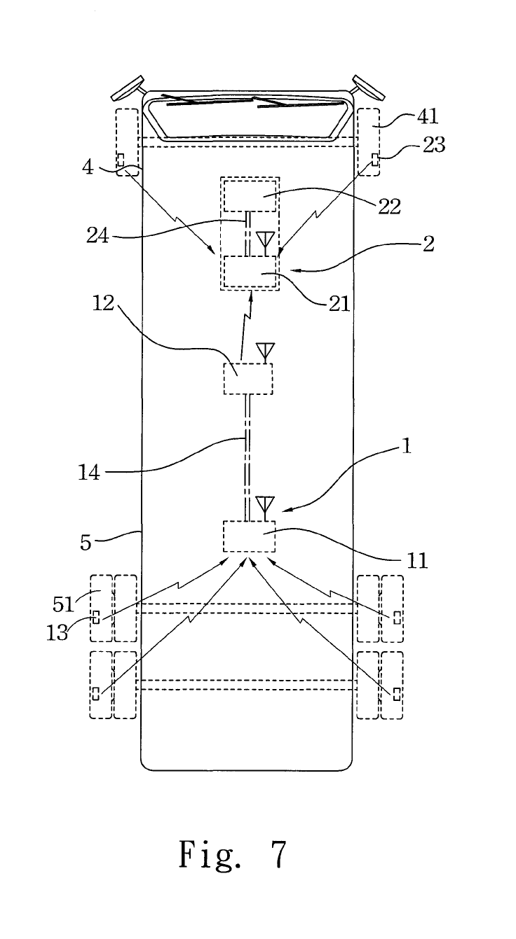

The fifth embodiment of the present invention, as shown in FIG. 7, mainly includes a first wireless module 1 and a second wireless module 2. It is noted the fifth embodiment is particularly suitable for use with a vehicle having integrally connected head portion 4 and body portion 5, such as a bus, a small-size truck, etc.

The first wireless module 1 and the second wireless module 2 in the fifth embodiment have structures similar to those in the first embodiment, except that the first wireless module 1 and the second wireless module 2 are mounted on the integral vehicle body at positions corresponding to the body portion 5 and the head portion 4 in the previous embodiments, respectively.

Moreover, in consideration of the effective range for receiving the tire pressure signals, tire pressure signals transmitted by the sensing units 23 mounted on the front tires 41 are directly received by the second wireless receiver 21 of the second wireless module 2 located near the head portion 4.

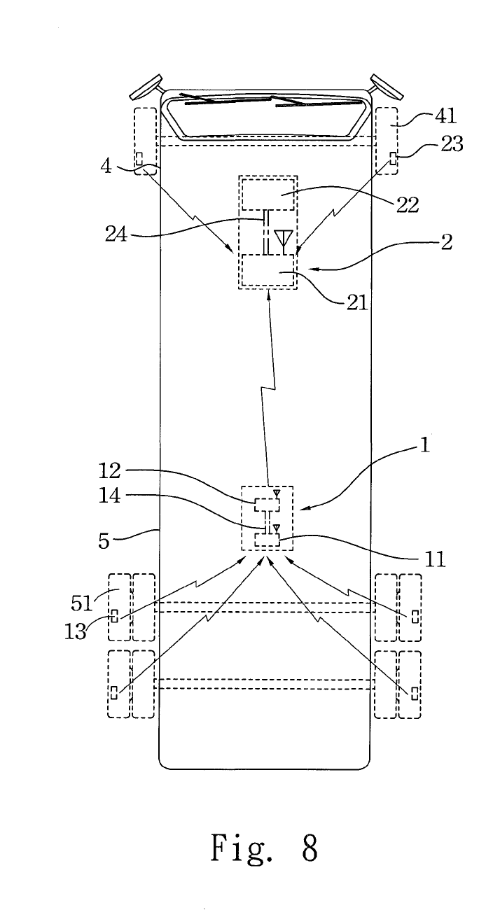

As shown in FIG. 8, the sixth embodiment of the present invention is a variation of the fifth embodiment. In the sixth embodiment, the first wireless transmitter 12 of the first wireless module 1 is not necessarily located at a position very close to the head portion 4, as long as the first wireless transmitter 12 is located near a signal receiving direction of the second wireless receiver 21 to allow good signal transmission to the second wireless receiver 21 via a shortest possible straight path.

With the above arrangements, the tire pressure monitoring system with bidirectional communication function according to the present invention allows tire pressure monitoring in an extended range, and the detected tire pressures may be remotely displayed on a different platform.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A tire pressure monitoring system with bidirectional communication function, comprising:
a plurality of sensing units being separately mounted on tires to be monitored, said tires being separately located at a head portion and a body portion of a vehicle, and said head portion and said body portion being integrally connected to one another; each of said sensing units including at least one pressure sensor, a microprocessor, a third power supply, and a third wireless transmitter; said pressure sensors being adapted to sense tire pressures of said tires to be monitored; said microprocessor being adapted to integrate and process the tire pressures of said tires being monitored, and send signals indicating the tire pressures to said third wireless transmitter; said third wireless transmitter being adapted to wirelessly transmit the received tire pressure signals; and said third power supply supplying power needed by said at least one pressure sensor, said microprocessor, and said third wireless transmitter;
a first wireless module being mounted on said body portion of said vehicle, and including a first wireless receiver and a first wireless transmitter; said first wireless receiver being located near a rear end of said vehicle body portion farther from said head portion for receiving tire pressure signals transmitted by said sensing units on said tires nearer the rear end of said body portion; said first wireless transmitter being located near a front end of said vehicle body portion closer to said vehicle head portion for receiving tire pressure signals from said first wireless receiver, and then wirelessly sending out the tire pressure signals; and
a second wireless module being mounted in the vehicle head portion, and including a second wireless receiver and a display unit; said second wireless receiver being adapted to receive tire pressure signals sent by said first wireless transmitter, and said display unit being adapted to receive said tire pressure signals from said second wireless receiver so as to display the tire pressures of said tires being monitored.

2. The tire pressure monitoring system with bidirectional communication function as claimed in claim 1, wherein said second wireless module further includes a second wireless transmitter.

3. The tire pressure monitoring system with bidirectional communication function as claimed in claim 2, wherein all of said wireless transmitters are radio-frequency (RF) transmitters, and all of said wireless receivers are radio-frequency (RF) receivers.

4. The tire pressure monitoring system with bidirectional communication function as claimed in claim 2, further comprising a portable monitoring module, which includes at least a fourth wireless receiver, a fourth power supply, and a display panel; said fourth wireless receiver being adapted to receive tire pressures signals transmitted from said second wireless transmitter, said display panel being adapted to directly show the tire pressures of said tires being monitored, and said fourth power supply supplying power needed by said fourth wireless receiver and said display panel.

5. The tire pressure monitoring system with bidirectional communication function as claimed in claim 4, wherein said portable monitoring module further includes a control interface and a fourth wireless transmitter, and said fourth power supply also supplies power needed by said control interface and said fourth wireless transmitter; whereby when a user operates on said control interface, a control signal is transmitted from said fourth wireless transmitter to said second wireless receiver.

6. The tire pressure monitoring system with bidirectional communication function as claimed in claim 5, wherein said fourth wireless transmitter is an RF transmitter, and said fourth wireless receiver is an RF receiver.

7. The tire pressure monitoring system with bidirectional communication function as claimed in claim 1, wherein said first wireless receiver is electrically connected to said first wireless transmitter via a first signal line.

8. The tire pressure monitoring system with bidirectional communication function as claimed in claim 1, wherein said second wireless receiver is electrically connected to said display unit via a second signal line.

9. A tire pressure monitoring system with bidirectional communication function, comprising:
a plurality of sensing units being separately mounted on tires to be monitored, said tires being separately located at a head portion and a body portion of a vehicle, and said head portion and said body portion being separably connected to one another; each of said sensing units including at least one pressure sensor, a microprocessor, a third power supply, and a third wireless transmitter; said pressure sensors being adapted to sense tire pressures of said tires to be monitored; said microprocessor being adapted to integrate and process the tire pressures of said tires being monitored, and send signals indicating the tire pressures to said third wireless transmitter; said third wireless transmitter being adapted to wirelessly transmit the received tire pressure signals; and said third power supply supplying power needed by said at least one pressure sensor, said microprocessor, and said third wireless transmitter;
a first wireless module including a first wireless receiver and a first wireless transmitter; said first wireless receiver being located near a rear end of said vehicle body portion farther from said head portion for receiving tire pressure signals transmitted by said sensing units on said tires nearer the rear end of said body portion; said first wireless transmitter being located near a front end of said vehicle body portion closer to said vehicle head portion for receiving tire pressure signals from said first wireless receiver, and then wirelessly sending out the tire pressure signals; and
a portable monitoring module including at least a fourth wireless receiver, a fourth power supply, and a display panel; said fourth wireless receiver being adapted to receive tire pressures signals transmitted from said first wireless transmitter, said display panel being adapted to directly show the tire pressures of said tires being monitored, and said fourth power supply supplying power needed by said fourth wireless receiver and said display panel.

10. The tire pressure monitoring system with bidirectional communication function as claimed in claim 9, wherein said portable monitoring module further includes a control interface and a fourth wireless transmitter, and said fourth power supply also supplies power needed by said control interface and said fourth wireless transmitter; whereby when a user operates on said control interface, a control signal is transmitted from said fourth wireless transmitter to said first wireless receiver.

11. The tire pressure monitoring system with bidirectional communication function as claimed in claim 10, wherein said first, said third, and said fourth wireless transmitter are RF transmitters, and said first and said fourth wireless receiver are RF receivers.

12. The tire pressure monitoring system with bidirectional communication function as claimed in claim 9, wherein said first wireless receiver is electrically connected to said first wireless transmitter via a first signal line.
